(19) United States
(12) Patent Application Publication
(10) Pub. No.: US 2016/0341412 A1
(43) Pub. Date: Nov. 24, 2016

(54) LED LIGHTING APPARATUS

(71) Applicant: ICEPIPE CORPORATION, Seoul (KR)

(72) Inventor: Dong Ju LEE, Gyeonggi-do (KR)

(73) Assignee: ICEPIPE CORPORATION, Seoul (KR)

(21) Appl. No.: 14/763,124

(22) PCT Filed: Apr. 3, 2015
(86) PCT No.: PCT/KR2015/003352

§ 371 Date: Jul. 23, 2015

(30) Foreign Application Priority Data
Dec. 31, 2014 (KR) 10-2014-0195667

(51) Int. Cl. F21V 29/51; F21V 29/77; F21K 9/66; F21V 15/01; F21V 29/80; F21V 19/00; F21V 29/89

(52) U.S. Cl. CPC F21V 29/51; F21V 19/003; F21V 29/77; F21V 29/89; F21V 15/01; F21V 29/80; F21K 9/66; F21Y 2115/10

(57) ABSTRACT

Provided is a light-emitting diode (LED) lighting apparatus including: a printed circuit board (PCB) having a planar structure; a LED chip mounted on a surface of the PCB; a support coupled to another surface of the PCB; and a heat sink that is coupled to the support and dissipates heat generated in the LED chip, wherein the support comprises a discontinuous through hole extending through two surfaces of the support, and the heat sink is coupled to the support when a portion of the heat sink inserted from a surface of the support into the through hole contacts the PCB.

### TECHNICAL FIELD

The inventive concept relates to a light-emitting diode (LED) lighting apparatus.

### BACKGROUND ART

In a light-emitting diode (LED) lighting apparatus, a large amount of heat is generated due to heat generated by an LED. In general, if the LED lighting apparatus is overheated, an operational error may be generated or the LED lighting apparatus may be damaged. Thus, a heat radiation structure preventing overheating is necessary. Also, a power supply for the LED also generates a large amount of heat and if the power supply is overheated, the lifespan of the power supply for the LED is reduced.

Korean Utility Model Publication No. 20-2009-0046370 discloses the related of the present inventive concept.

The LED lighting apparatus according to the related art may include an LED package in which a LED chip is packaged, a metal printed circuit board (PCB), on a top surface of which the LED package is mounted, and a heat sink mounted on a bottom surface of the metal PCB.

According to the related art, heat generated in the LED chip passes a package substrate of the LED package and the metal PCB to be transmitted to the heat sink. However, according to the related art, various components are mounted on a heat transfer path, and heat resistance of all components act on the heat transfer path, and thus the heat generated in the LED chip may not be efficiently dissipated.

Also, a structure and a manufacturing process of the LED lighting apparatus may be complicated, which is inefficient in terms of the cost and time.

### PRIOR ART

### Patent Document

Korean Utility Model No. 20-2009-0046370 (published on May 11, 2009)

### DETAILED DESCRIPTION OF THE INVENTIVE CONCEPT

### Technical Problem

The inventive concept provides a light-emitting diode (LED) lighting apparatus having a simple structure and a high heat radiation performance.

### Technical Solution

According to an aspect of the inventive concept, there is provided a light-emitting diode (LED) lighting apparatus including: a printed circuit board (PCB) having a planar structure; a LED chip mounted on a surface of the PCB; a support coupled to another surface of the PCB; and a heat sink that is coupled to the support and dissipates heat generated in the LED chip, wherein the support comprises a discontinuous through hole extending through two surfaces of the support, and the heat sink is coupled to the support when a portion of the heat sink inserted from a surface of the support into the through hole contacts the PCB.

The heat sink may include a heat pipe loop of an oscillating capillary tube type, the heat pipe loop being formed as capillary tubes into which a working fluid is injected and comprising a heat absorption portion coupled to the support to transfer heat and a heat dissipation portion configured to dissipate the heat absorbed by the heat absorption portion, wherein the heat pipe loop is coupled to the support when the heat absorption portion inserted from the surface of the support through the through hole contacts the PCB.

The heat sink may include a heat radiation structure formed of a thermally conductive metal in the form of a wire or a coil.

The support and the heat sink may be coupled to each other by using a thermally conductive adhesive.

The heat pipe loop may have a spiral structure and is disposed in a loop shape so as to form the heat dissipation portion of a radial shape.

### Advantageous Effects

According to one or more embodiments of the inventive concept, a light-emitting diode (LED) lighting apparatus having a simple structure and a high heat radiation performance may be manufactured as a portion of a heat sink passes through a support to contact a printed circuit board to be coupled to the support.

### DESCRIPTION OF THE DRAWINGS

FIG. 1 is a perspective view illustrating a light-emitting diode (LED) lighting apparatus according to an exemplary embodiment of the inventive concept;

FIG. 2 is a disassembled perspective view illustrating a LED lighting apparatus according to an exemplary embodiment of the inventive concept;

FIG. 3 is a cross-sectional view illustrating a LED lighting apparatus according to an exemplary embodiment of the inventive concept;

FIG. 4 is a detailed view illustrating a LED lighting apparatus according to an exemplary embodiment of the inventive concept, in which a printed circuit board (PCB), a support, and a heat sink are coupled to one another; and

FIG. 5 illustrates a LED lighting apparatus according to an exemplary embodiment of the inventive concept, in which a heat sink is inserted into a through hole of a support.

### BEST MODE

The terms used herein are for illustrative purpose of the inventive concept only and should not be construed to limit the meaning or the scope of the inventive concept as described in the claims. Singular expressions, unless defined otherwise in contexts, include plural expressions.

Also, when a part “includes” an element, unless there is a particular description contrary thereto, the part can further include other elements, not excluding the other elements. Additionally, when an element is referred to as being “on” another element, it can be placed on or below the other element, and it does not necessarily mean that the element is on the other element in a direction of gravity.

In the present specification, when a constituent element is “coupled” to another constituent element, it may be construed that the constituent element is coupled to the other constituent element not only directly but also through at least one of other constituent elements interposed therebetween.

It will be understood that, although the terms first, second, etc. may be used herein to describe various elements, these elements should not be limited by these terms. These terms are only used to distinguish one element from another.

In other words, since sizes and thicknesses of components in the drawings are arbitrarily illustrated for convenience of explanation, the following embodiments are not limited thereto.

The LED lighting apparatus according to exemplary embodiments of the inventive concept will be described below in more detail with reference to the accompanying drawings. Those components that are the same or are in correspondence are rendered the same reference numeral regardless of the figure number, and redundant explanations are omitted.

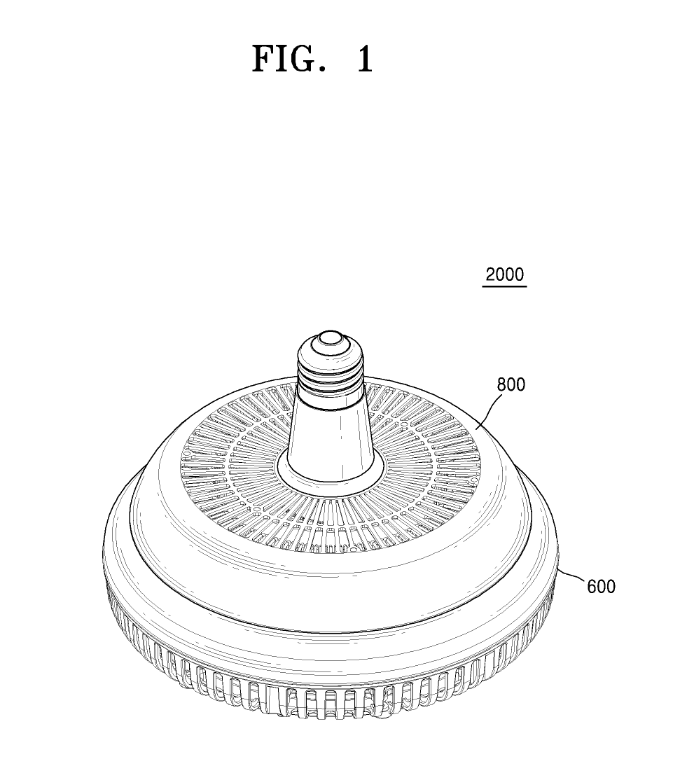

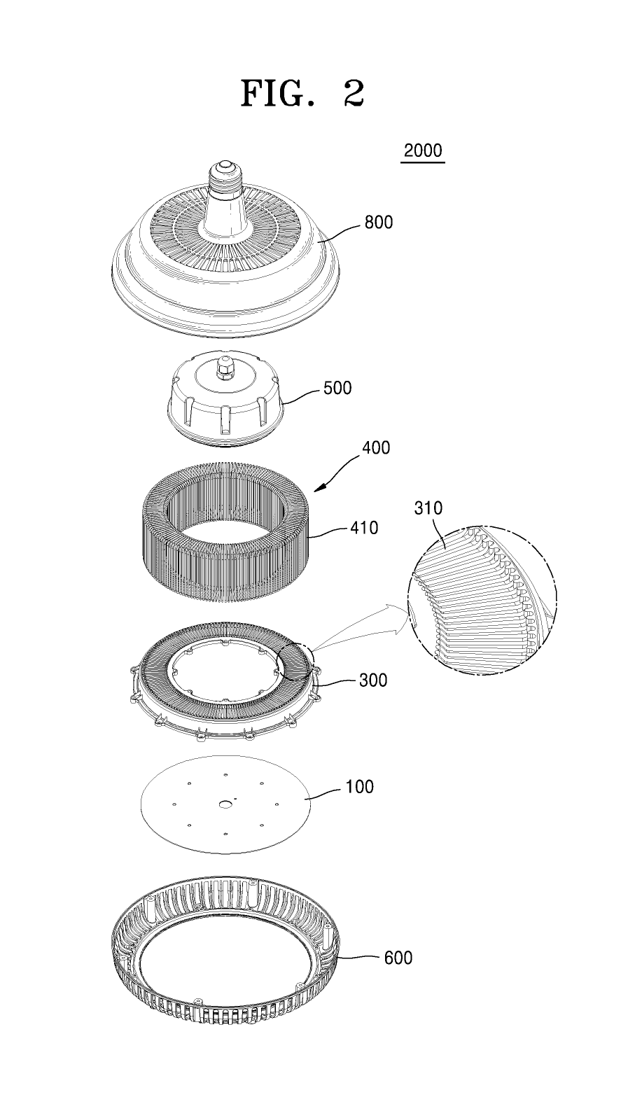

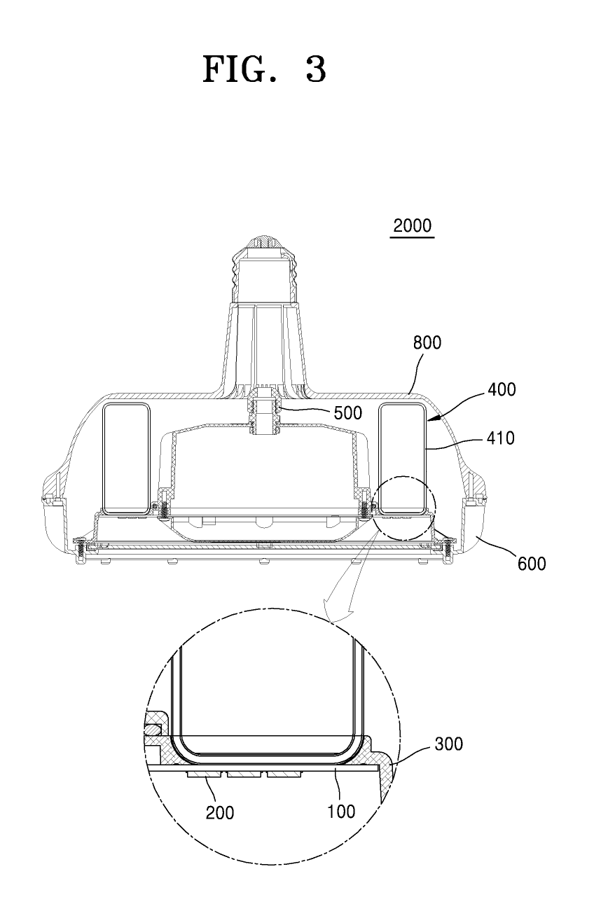

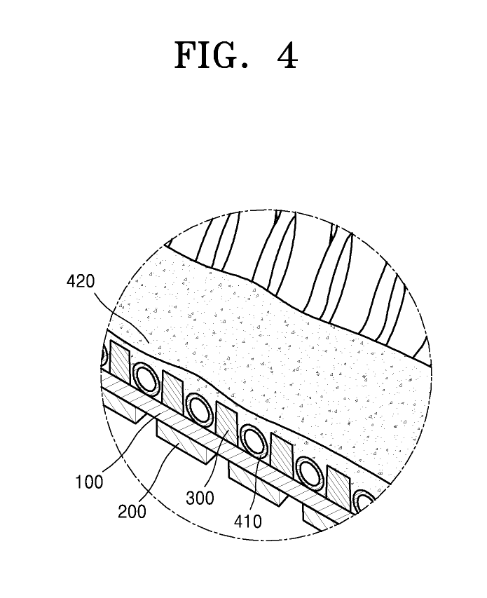

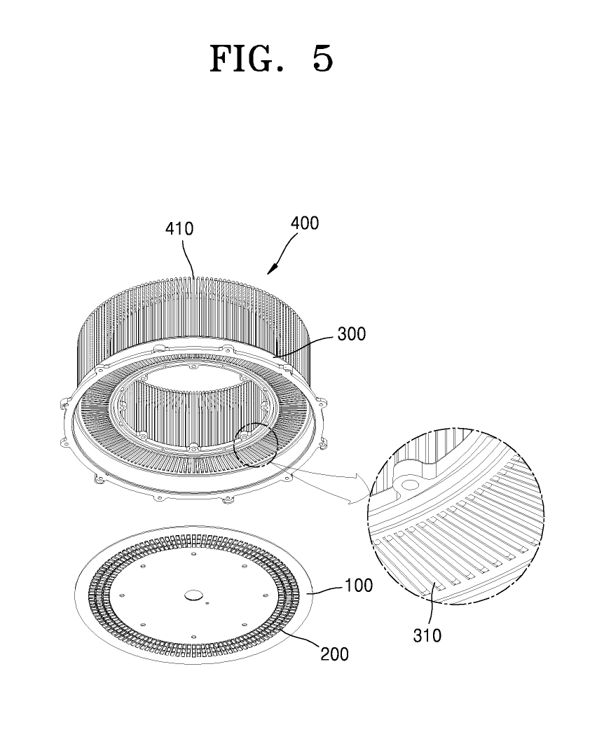

FIG. 1 is a perspective view illustrating a light-emitting diode (LED) lighting apparatus 2000 according to an exemplary embodiment of the inventive concept. FIG. 2 is a disassembled perspective view illustrating the LED lighting apparatus 2000 according to an exemplary embodiment of the inventive concept. FIG. 3 is a cross-sectional view illustrating the LED lighting apparatus 2000 according to an exemplary embodiment of the inventive concept. FIG. 4 is a detailed view illustrating the LED lighting apparatus 2000 according to an exemplary embodiment of the inventive concept, in which a printed circuit board (PCB) 100, a support 300, and a heat sink 400 are coupled to one another. FIG. 5 illustrates the LED lighting apparatus 2000 according to an exemplary embodiment of the inventive concept, in which a heat sink is inserted into a through hole of a support.

As illustrated in FIGS. 1 through 5, the LED lighting apparatus 2000 includes the PCB 100, a LED chip 200, the support 300, and the heat sink 400.

The PCB 100 may have a planar structure, and the LED chip 200 may be mounted on one surface of the PCB 100 and the support 300 is coupled to the other surface of the PCB 100. The PCB 100 may be formed of an insulation layer such as FR-4 and a circuit pattern formed on the insulation layer.

The LED chip 200 is mounted on the one surface of the PCB 100 and may emit light by using electrical energy. In this case, the LED chip 200 may be, for example, a LED package formed of a package substrate and an LED device that is mounted on the package substrate to be packaged. A structure, the number, and arrangement of the LED chip 200 may be selected in various manners according to necessity.

The support 300 is coupled to the other surface of the PCB 100, and may be an auxiliary member that allows more stable coupling between the PCB 100 and the heat sink 400.

The heat sink 400 is coupled to the support 300 so as to dissipate heat generated in the LED chip 200, and may dissipate the heat of the LED chip 200 that is transferred through the PCB 100 and the support, by using heat conduction or heat convection.

Meanwhile, the heat sink 400 is not limited to the structures illustrated in FIGS. 1 through 5, and a heat radiation structure that is formed of a thermally conductive metal such as copper, in a wire or coil form, may be used as the heat sink 400. The heat sink 400 may be modified in various manners according to necessity. In particular, the heat sink 400 may have a structure capable of maximizing heat radiation efficiency such as a heat radiation fin structure.

A discontinuous through hole 310 that passes through two surfaces of the support 300 is formed in the support 300, and a portion of the heat sink 400 is inserted into the through hole 310 from one surface of the support 300 to thereby contact the PCB 100 so that the heat sink 400 is coupled to the support 300.

In this case, the discontinuous through hole 310 refers to a plurality of through holes 310 that are discontinuously formed along the one surface of the support 300 without being connected to one another.

In particular, as illustrated in FIGS. 4 and 5, the heat sink 400 has a heat radiation fin structure, in which respective heat radiation fins are inserted into the through holes 310 so as to directly contact the PCB 100.

That is, a fin implantation in PCB (FIIP) structure may be formed, in which a thermally conductive adhesive layer is formed on one surface of the PCB 100 and respective heat radiation fins are buried in the thermally conductive adhesive layer so that the heat radiation fins are disposed within the PCB 100 or pass through the support 300 to be coupled to the PCB 100.

In the FIIP structure, a thermal interface material (TIM) that is additionally interposed between the LED chip 200 and the PCB 100 and the heat sink 400 may be prevented from the start.

As described above, according to the LED lighting apparatus 2000 according to the present exemplary embodiment, heat generated in the LED chip 200 does not pass through a complicated heat transfer path but is dissipated through the heat sink 400 that is directly coupled to the PCB 100, thereby minimizing heat resistance and increasing a heat radiation efficiency.

In the LED lighting apparatus 1000 according to the present exemplary embodiment, the heat sink 400 may include a heat pipe loop 410 of an oscillating capillary tube type, which is formed as capillary tubes into which a working fluid is injected and comprises a heat absorption portion coupled to the support 300 to transfer heat and a heat dissipation portion that dissipates the heat absorbed by the heat absorption portion. The heat pipe loop 410 may be coupled to the support 300 as the heat absorption portion of the heat pipe loop 410 is inserted from the one surface of the support 300 into the through hole to contact the PCB 100.

Accordingly, as the respective heat absorption portions are inserted into corresponding through holes 310 to be coupled to the support 300, a portion of heat generated in a heat generating body may not pass the support 300 but be directly transferred from the PCB 100 to the heat pipe loop 410.

As a result, a position of the heat absorption portion may be further stably fixed, and a heat transfer path may be simplified, thereby preventing a decrease in heat radiation efficiency.

In this case, as illustrated in FIGS. 1 through 5, a portion of the heat pipe loop 410 that is coupled to the support 300 may be the heat absorption portion that receives heat from the support 300. Also, an external portion of the heat pipe loop 410 separated from the support 300 may be a major heat dissipation portion.

In particular, the heat pipe loop 410 is formed of an oscillating capillary tube type heat pipe that uses a fluid dynamic pressure, and thus may quickly dissipate a large amount of heat. Also, the heat pipe having a capillary tube structure is light-weight, and thus, the LED lighting apparatus 2000 according to the present exemplary embodiment may be structurally stable.

A working fluid and bubbles each having a predetermined ratio are injected into the heat pipe of the oscillating capillary tube type, and then the inside of the capillary tube is sealed with respect to the outside. Accordingly, the oscillating capillary tube type heat pipe has a heat transfer cycle whereby a large amount of heat is transported as a latent heat by volume expansion and condensation of the bubbles and the working fluid.

A heat transfer mechanism operates such that nucleate boiling is generated by an amount of the absorbed heat in the heat absorption portion that has absorbed heat so that bubbles in the heat absorption portion expand in volume. The capillary tube maintains a uniform internal volume, and thus bubbles in the heat dissipation portion that emits light are shrunk by an amount of heat corresponding to the amount of the bubbles that expanded in volume.

Thus, as a balance of pressure in the capillary tube is destroyed, a flow including vibration of the working fluid and bubbles occurs in the capillary tube, resulting in a rise in a temperature due to a change in bubble volume and transportation of the latent heat, and thereby dissipating heat.

Here, the oscillating capillary tube type heat pipe may include a capillary tube formed of a metal material such as copper or aluminum which has a high heat conductivity. Accordingly, heat may be conducted fast and a change in volume of bubbles injected into the heat pipe may be quickly generated.

In the LED lighting apparatus 2000 according to the present exemplary embodiment, the support 300 and the heat sink 400 may be coupled to each other by using a thermally conductive adhesive 420. In this case, the support 300 and the heat sink 400 may be formed of different materials from each other.

If the support 300 and the heat sink 400 are formed of different materials from each other, an adhesive may be used to couple the support 300 and the heat sink 400, but use of a typical adhesive may degrade heat conduction performance.

Thus, by coupling the support 300 and the heat sink 400 by using the thermally conductive adhesive 420 having a high heat conductivity, degradation in heat radiation efficiency may be prevented.

In the LED lighting apparatus 2000 according to the present exemplary embodiment, the other surface of the support 300 may be polished to a surface of a mirror. In this case, polishing refers to grinding a surface to be smooth, and the other surface of the support 300 may be formed to a surface of a mirror with a relatively small friction through the above polishing.

Here, the LED lighting apparatus 2000 according to the present exemplary embodiment may further include a temporary plate (not shown) that is detachably coupled to the other surface of the support 300 so as to cover the other surface of the support 300.

That is, the temporary plate (not shown) may be attached to the other surface of the support 300 to protect the other surface of the support 300 during a manufacturing process or increase surface uniformity thereof. Also, if an additional member such as the PCB 100 is to be coupled to the other surface of the support 300 in the manufacturing process, the temporary plate may be detached from the other surface of the support 300 and then the additional member may be coupled thereto.

In this case, the other surface of the support 300 is formed to a surface of a mirror with a relatively small friction, and thus the temporary plate may be easily detached from the other surface of the support 300.

In the LED lighting apparatus 2000 according to the present exemplary embodiment, the heat pipe loop 410 may have a spiral structure and is disposed in a loop shape so as to form the heat dissipation portion of a radial shape.

In detail, as illustrated in FIGS. 1 through 3, the heat pipe loop 410 is formed of unit loops that are continuously connected to one another, and may have a spiral structure. The spiral structure described above, in which capillary tubes are wound at dense intervals, allows efficient arrangement of long capillary tubes in a limited space.

Moreover, the heat pipe loop 410 according to the present exemplary embodiment may be in a loop shape, and two ends of the heat pipe loop 410, which has a spiral structure, may be connected to each other. Thus, the heat pipe loop 410 may be radial shaped and have a hollow center portion, and thus the heat pipe loop 410 may have high permeability regardless of the installation direction thereof. Therefore, the heat pipe loop 410 may have excellent heat dissipation regardless of the installation direction.

In this case, the heat pipe loop 410 may be an open loop or a closed loop. Also, when a plurality of heat pipe loops 410 are included, all or some of the heat pipe loops 410 may be fluidly connected to adjacent heat pipe loops 410. Thus, each of the heat pipe loops 410 may have an overall open or closed loop shape according to necessity in terms of design.

Also, although the heat pipe loop 410 having a spiral structure in which unit loops are continuously connected is provided in the present exemplary embodiment, the embodiments of the inventive concept are not limited thereto, and the form of the heat pipe loop 410 may include various shapes such as a structure in which individual unit loops are sequentially arranged.

The power supply unit 500 supplies power to the LED chip 200, and may include a power supply device that may be applied to the LED lighting apparatus 2000, such as a switching mode power supply (SMPS).

The cover member 600 may protect internal components and induce an efficient air flow. The cover member 600 may be formed of a transparent material that transmits through light, and may be coupled to a base 800 so as to cover internal components.

The cover member 600 covers a lateral surface and a lower portion of the LED lighting apparatus 2000 so as to cover internal components of the LED lighting apparatus 2000 to thereby protect the internal components from external impact and pollution.

The base 800 surrounds a lateral surface and an upper portion of the LED lighting apparatus 2000 so as to cover internal components of the LED lighting apparatus 2000 to thereby be coupled to the cover member 600. The base 800 may be formed of an insulation material such as a synthetic resin.

An electrical connection portion 700 may be coupled to an end portion of the base 800. The electricity connection portion 700 may be a socket having a structure such as an Edison type structure or a Swan type structure.

A through hole may be formed in a top surface of the base 800 in all directions, and air flowing in a horizontal direction around the base 800 may also pass through the base 800, thereby further improving heat dissipation.

While this invention has been particularly shown and described with reference to exemplary embodiments thereof, it will be understood by those of ordinary skill in the art that various changes may be made therein without departing from the spirit and scope of the inventive concept.

### EXPLANATIONS FOR REFERENCE NUMERALS

100: printed circuit board
200: LED chip
300: support
310: through hole
400: heat sink
410: heat pipe loop
420: thermally conductive adhesive
500: power supply unit
600: cover member
700: electrical connection portion
800: base
2000: LED lighting apparatus

1. A light-emitting diode (LED) lighting apparatus comprising:
a printed circuit board (PCB) having a planar structure;
a LED chip mounted on a surface of the PCB;
a support coupled to another surface of the PCB; and
a heat sink that is coupled to the support and dissipates heat generated in the LED chip,
wherein the support comprises a discontinuous through hole extending through two surfaces of the support, and
the heat sink is coupled to the support when a portion of the heat sink inserted from a surface of the support into the through hole contacts the PCB.

2. The LED lighting apparatus of claim 1, wherein the heat sink comprises a heat pipe loop of an oscillating capillary tube type, the heat pipe loop being formed as capillary tubes into which a working fluid is injected and comprising a heat absorption portion coupled to the support to transfer heat and a heat dissipation portion configured to dissipate the heat absorbed by the heat absorption portion,
wherein the heat pipe loop is coupled to the support when the heat absorption portion inserted from the surface of the support through the through hole contacts the PCB.

3. The LED lighting apparatus of claim 1, wherein the heat sink comprises a heat radiation structure formed of a thermally conductive metal in the form of a wire or a coil.

4. The LED lighting apparatus of claim 1 wherein the support and the heat sink are coupled to each other by using a thermally conductive adhesive.

5. The LED lighting apparatus claim 1 wherein the heat pipe loop has a spiral structure and is disposed in a loop shape so as to form the heat dissipation portion of a radial shape.

6. The LED lighting apparatus of claim 2 wherein the support and the heat sink are coupled to each other by using a thermally conductive adhesive.

7. The LED lighting apparatus of claim 3 wherein the support and the heat sink are coupled to each other by using a thermally conductive adhesive.

8. The LED lighting apparatus claim 2 wherein the heat pipe loop has a spiral structure and is disposed in a loop shape so as to form the heat dissipation portion of a radial shape.

9. The LED lighting apparatus claim 3 wherein the heat pipe loop has a spiral structure and is disposed in a loop shape so as to form the heat dissipation portion of a radial shape.
